(19) United States
(12) Patent Application Publication
(10) Pub. No.: US 2013/0221594 A1
(43) Pub. Date: Aug. 29, 2013

(54) CLAMPING MECHANISM

(71) Applicant: QING-SONG WEN, Shenzhen (CN)

(72) Inventor: QING-SONG WEN, Shenzhen (CN)

(21) Appl. No.: 13/714,321

(22) Filed: Dec. 13, 2012

(30) Foreign Application Priority Data
Feb. 24, 2012 (CN) 201210043500.4

(51) Int. Cl. B23Q 3/06

(52) U.S. Cl. CPC B23Q 3/069
USPC 269/233

(57) ABSTRACT

A clamping mechanism includes a base, a clamping block rotatably connected with the base, an eccentric handler and a guiding member. The eccentric handler defines a hinging hole and a sliding slot. Part of the sliding slot is eccentrically positioned relatively to the hinging hole. The eccentric handler hinges on the base via the hinging hole. The guiding member passes through the sliding slot and is movably connected with the clamping block. The eccentric handler pivots to enable and to force the guiding member to move along the sliding slot for clamping and releasing a workpiece placed on the base.

### BACKGROUND

1. Technical Field

The present disclosure relates to clamping mechanisms, particularly to a clamping mechanism for quickly clamping and releasing workpieces.

2. Description of Related Art

A clamping mechanism holds workpieces for assembling, processing, or transmitting the workpieces. The clamping mechanism may include a base and a clamping block. The base and the clamping block are connected with each other via an adjustable screw, which enables adjustment of the distance between the clamping block and the base according to a size of the workpiece to be clamped between the base and a clamping block. However, during a clamping process, the screw must to be adjusted to allow a suitable distance for the workpiece, a process which is a complex and time-consuming operation. Furthermore when the clamping and releasing have to be done at a fast rate, work efficiency may be relatively low.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a clamping mechanism including an eccentric handler and a base.

FIG. 2 is an exploded, isometric view of the clamping mechanism shown in FIG. 1.

FIG. 3 is a planar view of the eccentric handler of the FIG. 1.

FIG. 4 is a sectional view of the clamping mechanism shown in FIG. 1 in an unclamping state with a workpiece placed on the base.

FIG. 5 is similar as FIG. 4, but the clamping mechanism in a middle state before clamping the workpiece firmly.

FIG. 6 is similar as FIG. 4, but showing a fully clamping state of the clamping mechanism in relation to the workpiece.

### DETAILED DESCRIPTION

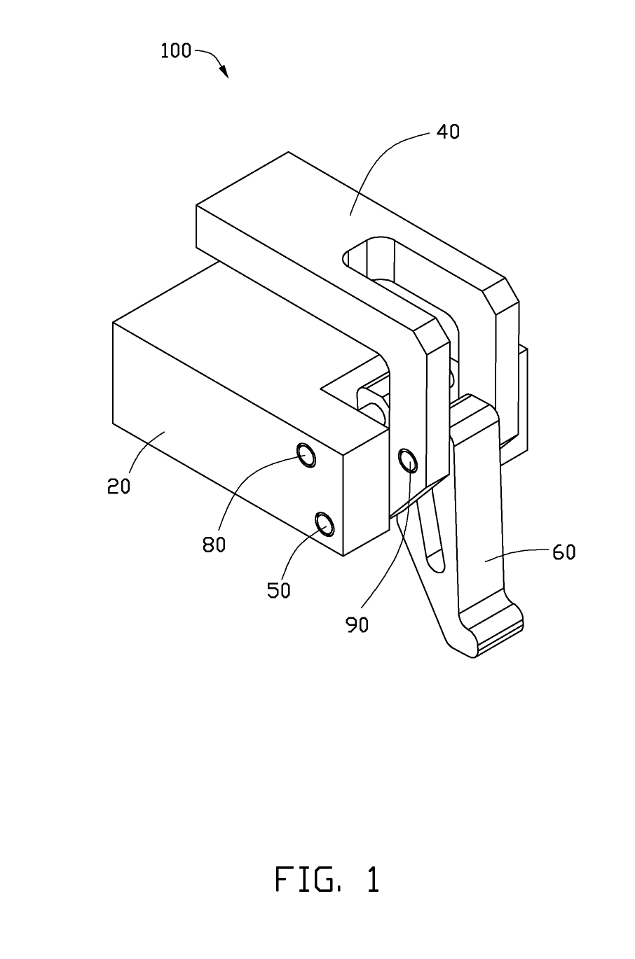

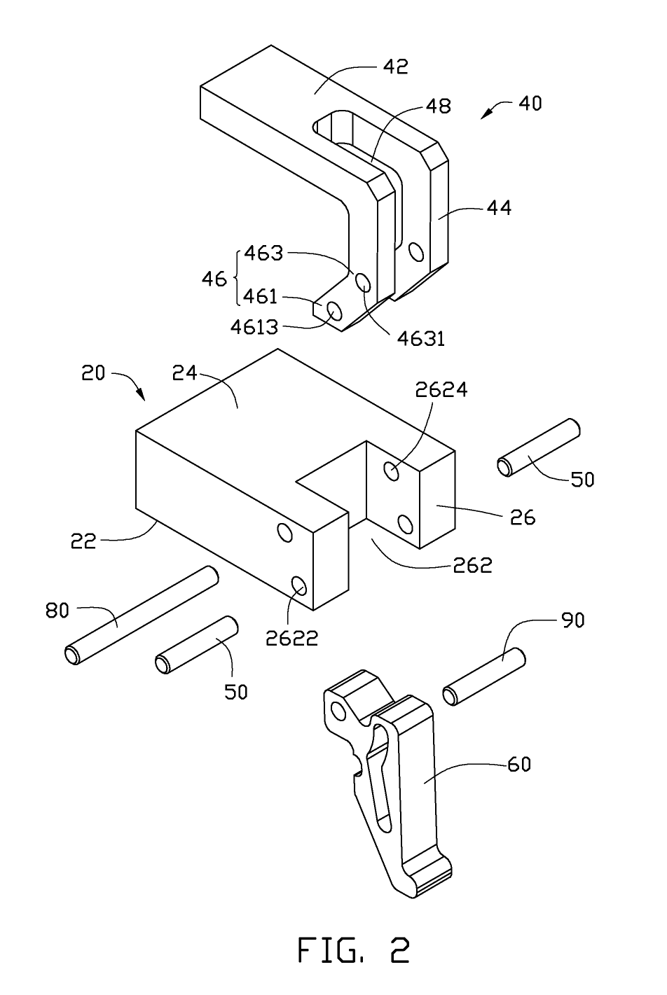

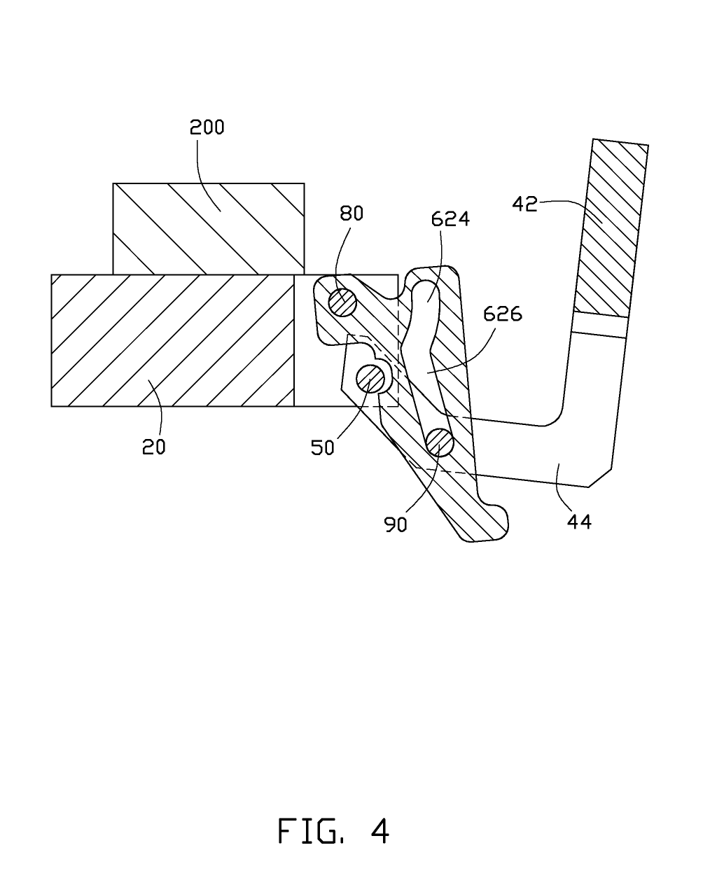

FIGS. 1 and 2 show a clamping mechanism 100 for clamping a workpiece 200 (as shown in FIG. 4). The clamping mechanism 100 includes a base 20, a clamping block 40, two pivots 50, an eccentric handler 60, a shaft 80 and a guiding member 90. The clamping block 40 is rotatably connected with the base 20 via the two pivots 50. The eccentric handler 60 is hinged with the base 20 via the shaft 80 and movably connected with the clamping block 40 via the guiding member 90. The eccentric handler 60 is used for driving the clamping block 40 to rotate around the base 20 for clamping or releasing the workpiece 200 placed on the base 20. In the illustrated embodiment, the two pivots 50, the shaft 80 and the guiding member 90 are heavy duty pins.

The base 10 is substantially cuboid shaped, and includes a bottom portion 22, a mounting portion 24 opposite to the bottom portion 22, and a side portion 26 connecting the bottom portion 22 to the mounting portion 24. In the illustrated embodiment, the mounting portion 24 is flat. In other embodiments, the structure of the mounting portion 24 may be configured to engage with the workpiece 200. A U-shaped mounting groove 262 is defined in the side portion 26. Two first pivot holes 2622 and two second pivot holes 2624 are defined through opposite side walls of the mounting groove 262. The first pivot holes 2622 are positioned away from a bottom wall of the mounting groove 262, and the two second pivot holes 2624 are positioned adjacent to the bottom wall of the mounting groove 262.

The clamping block 40 is substantially L-shaped, and includes a clamping portion 42, a connecting portion 44 and a rotating portion 46. The connecting portion 44 connects the clamping portion 42 to the rotating portion 46. The clamping portion 42 is substantially a planar board and is positioned facing the mounting portion 24. The connecting portion 44 extends substantially perpendicularly from one end of the clamping portion 42. The rotating portion 46 is bent from an end of the connecting portion 44 away from the clamping portion 42. The rotating portion 46 and the clamping portion 42 are positioned at a same side of the connecting portion 44. The rotating portion 46 includes a first connecting end 461 and a second connecting end 463 opposite to the first connecting end 461. The first connecting end 461 is rotatably connected with the base 20 away from the connecting portion 44. Two first rotating holes 4613 are defined in the first connecting end 461 corresponding to the first pivot holes 2622. The second connecting end 463 connects to the connecting portion 44. Two second rotating holes 4631 are defined on a joint portion between the second connecting end 463 and the connecting portion 44. A substantially U-shaped inserting groove 48 is defined through the clamping block 40, and extends from the first connecting end 461 towards a middle of the clamping portion 42.

Each pivot 50 passes through one first rotating hole 4613 and a corresponding first pivot hole 2622 for hinging the clamping block 40 and the base 20 together. A part of the pivot 50 protrudes from the first rotating hole 4613. In other embodiments, the two pivots 50 may be designed as a single pivot. The pivot passes through the first rotating holes 4613, and two ends of the pivot are hinged with the two first pivot holes 2622.

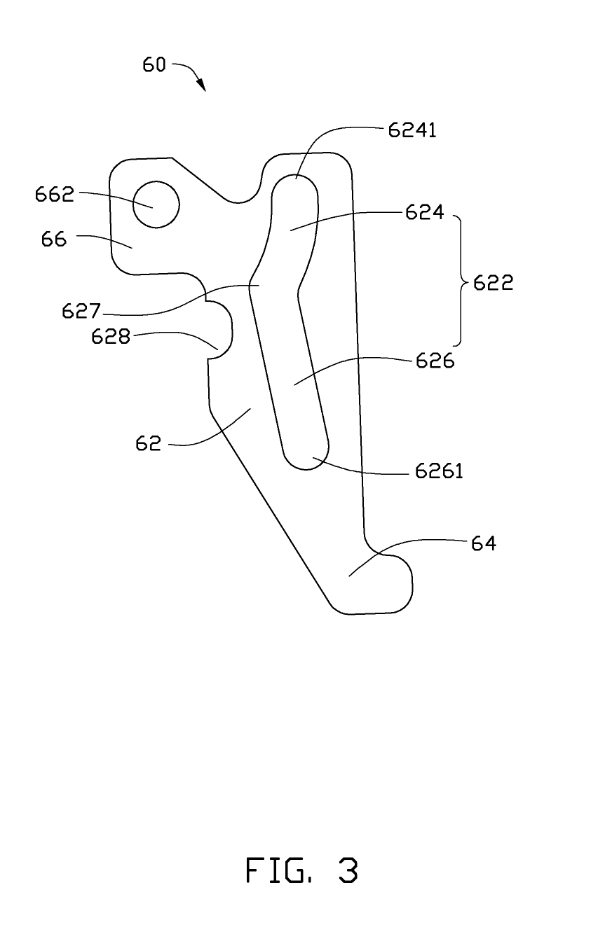

Also referring to FIG. 3, the eccentric handler 60 includes a base body 62, a holding portion 64 and a hinging portion 66. The holding portion 64 is bent from one end of the base body, and the hinging portion 66 is bent from another end of the base body 62. The holding portion 64 and the hinging portion 66 are positioned at opposite ends of the base body 62. A hinging hole 662 is defined through the hinging portion 66. A sliding slot 622 is defined through the base body 62 extending from an end of the base body connecting with the hinging portion 66 to another end which is connecting with the holding portion 64. The sliding slot 622 includes a first sliding segment 624 and a second sliding segment 626. The first sliding segment 624 is arc-shaped, and is eccentrically positioned relative to the hinging hole 662. The second sliding segment 626 is substantially straight, and extends from one end of the first sliding segment 624 towards the holding portion 64. The second sliding segment 626 communicates with the first sliding segment 624. An end of the first sliding segment 624 away from the second sliding segment 626 is defined as a top end 6241. A joint of the first sliding segment 626 and the second sliding segment 626 is defined as a connecting end 627. An end of the second sliding segment 626 away from the first sliding segment 624 is defined as a bottom end 6261. A substantially semicircular position groove 628 is formed on one edge of the base body 62 adjacent to the hinged portion 66.

The shaft 80 passes through one second pivot hole 2624, the hinging hole 662 and the other second pivot hole 2624 to hinge the base 20 and the eccentric handler 60 together.

The guiding member 90 is a rod, and passes through one second rotating hole 4631, the sliding slot 622, and another second rotating hole 4631 to pivot the clamping block 40 and the eccentric handler 60 together.

In assembly, the rotating portion 46 is inserted into the mounting groove 262. Thereby the base 20 is rotatably connected with the clamping block 40 via the two pivots 50. The hinging portion 66 of the eccentric handler 60 passes through the inserting groove 48 and enters the mounting groove 262. The hinging portion 66 is hinged with the base 20 via the shaft 80. Finally, the clamping block 40 is movably connected with the eccentric handler 60 via the guiding member 90.

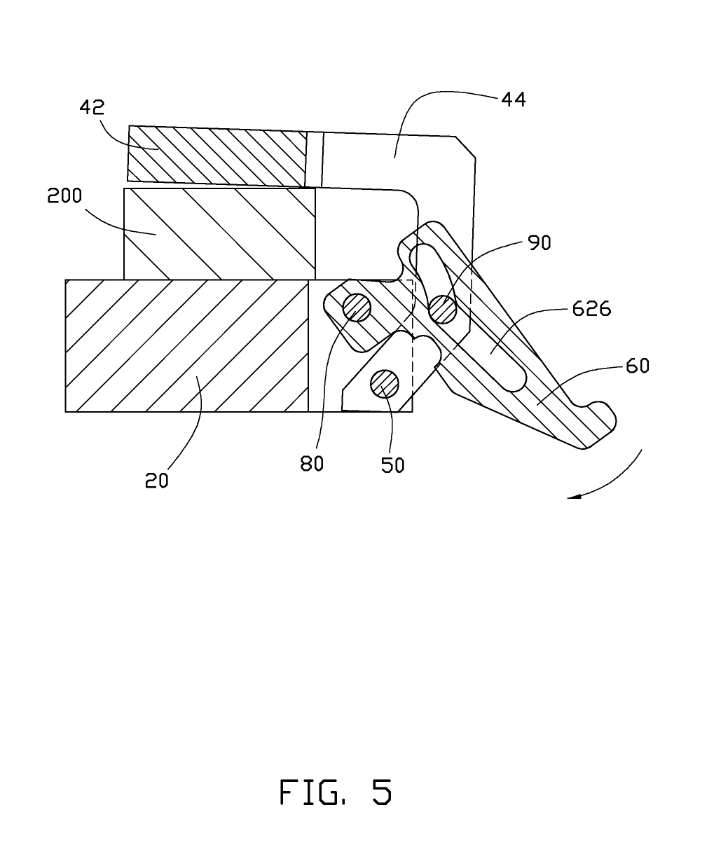

FIGS. 4 through 6 show a working process of the clamping mechanism 100 whereby the workpiece 200 is clamped. The base 20 is placed on a work table (not shown) and the bottom portion 22 is positioned towards the work table. FIG. 1 shows a state of the clamping mechanism 100 without a workpiece 200 and the clamping portion 42 above the mounting portion 24 in an initial state. The eccentric handler 60 is rotated counterclockwise, to enable the guiding member 90 to slide along the first sliding segment 624 towards the second sliding segment 626, then the clamping block 40 is rotated clockwise to move away from the mounting portion 24. The eccentric handler 60 rotates clockwise around the shaft 80 when the guiding member 90 arrives at the connecting end 627 (this is the middle state). Then the guiding member 90 slides along the second sliding segment 626 towards the bottom end 6261 as the clamping block 40 rotates clockwise. The clamping mechanism 100 is in a fully unclamping state (as shown in FIG. 4) when the guiding member 90 reaches the bottom end 6261. The workpiece 200 is positioned on the mounting portion 24.

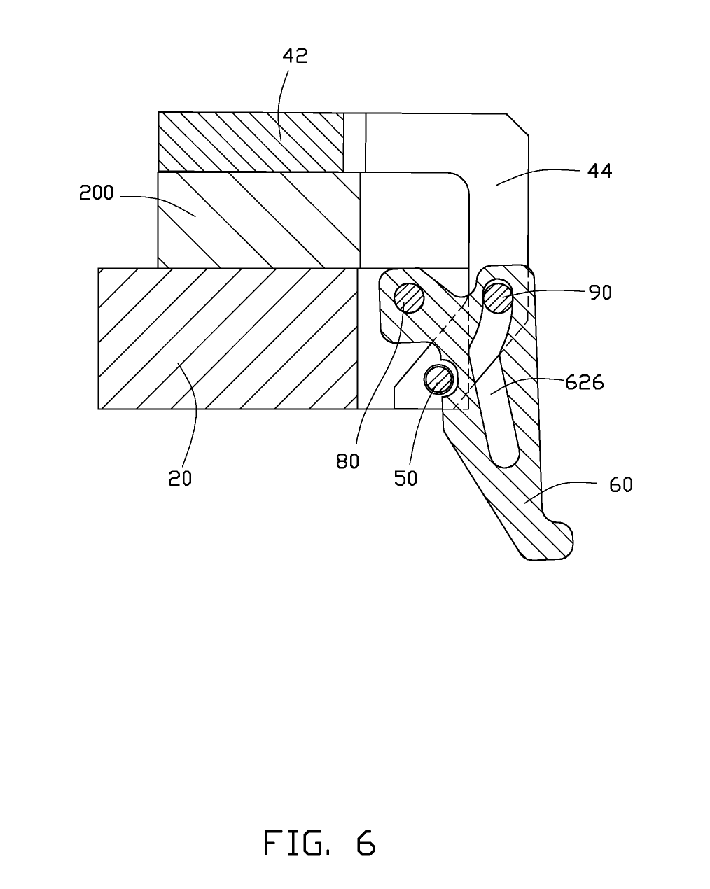

The eccentric handler 60 is rotated counterclockwise around the shaft 80, to enable the guiding member 90 to slide along the second sliding segment 626 towards the first sliding segment 624, then the clamping block 40 rotates counterclockwise. The eccentric handler 60 is driven to rotate clockwise when the guiding member 90 arrives at the connecting end 627. The clamping block 90 is driven towards the mounting portion 24. Finally, the workpiece 200 is wholly clamped between the clamping portion 42 and the mounting portion 24, when the guiding member 90 arrives at the top end 6241. The clamping mechanism 100 is then in a fully clamping state (as shown in FIG. 6), the pivots 50 resist against sidewalls of the position groove 628, and the eccentric handler 60 is locked in position.

The structure of the clamping mechanism 100 is simple. The eccentric handler 60 has the hinging hole 662, the first sliding segment 624 is eccentrically positioned relative to the hinging hole 662, and the second sliding segment 626 communicates with the first sliding segment 624. The clamping mechanism 100 clamps and releases the workpiece 200 quickly and reliably via a simple operation carried out on the eccentric handler 60. In addition, the position groove 628 is formed on the an edge of the base body 62 adjacent to the hinging portion 66, and the shaft 80 resists against the side wall of the position groove 628 when the clamping block 40 has fully clamped the workpiece 200, preventing further movement of the eccentric handler 60.

The pivots 50 may be omitted, their place taken by protrusions which are formed on side walls of the mounting groove 262 or on the side walls of the first connecting end 461 facing the sidewalls of the mounting groove 262, then the clamping block 40 hinges on the base 40 by means of the protrusions.

In other embodiments, similar protrusions may be formed on side walls of the base to replace the shaft 80, providing a hinge for the eccentric handler 60.

In other embodiments, the inserting groove 48 may be omitted, an installing portion being formed on the base 20 and the eccentric handler 60 being movably assembled directly on the installing portion.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A clamping mechanism, comprising:
a base;
a clamping block rotatably connected with the base;
an eccentric handler defining a hinged hole and a sliding slot, a part of the sliding slot being eccentrically positioned relatively to the hinged hole, the eccentric handler hinged with the base via the hinged hole; and
a guiding member passing through the sliding slot and movably connected with the clamping block,
wherein the eccentric handler is driven to enable and to force the guiding member to slide along the sliding slot for clamping and releasing a workpiece on the base.

2. The clamping mechanism of claim 1, wherein the sliding slot comprises a first sliding segment and a second sliding segment extending from an end of the first sliding segment and communicating with the first sliding segment, the first sliding segment is arc-shaped and is eccentrically positioned relatively to the hinged hole.

3. The clamping mechanism of claim 2, wherein the eccentric handler comprises a base body, a holding portion and a hinged portion, the holding portion is formed by bending one end of the base body, and the hinged portion is formed by bending another end of the base body, the holding portion and the hinged portion are positioned at opposite ends of the base body, the hinged hole is positioned on the hinged portion, the first sliding segment and the second sliding segment are positioned on the base body, the second sliding segment is positioned adjacent to the hold portion.

4. The clamping mechanism of claim 3, wherein the base body comprise a position groove positioned on an edge of the base body adjacent to the hinged portion, the clamping mechanism further comprises a pivot, the clamping block is hinged with the base via the pivot, the pivot resists against a sidewall of the position groove when the guiding member reaches an end of the first sliding segment away from the second sliding slot.

5. The clamping mechanism of claim 1, wherein the clamping mechanism further comprises two pivots, each of the two pivot passes through the base and the clamp block to rotatably connect to the base and the clamping block.

6. The clamping mechanism of claim 1, wherein the base comprises a bottom portion, a mounting portion opposite to the bottom portion, and a side portion connecting with the bottom portion and the mounting portion, a mounting groove is defined on the side portion, the clamping block extends into the mounting groove to rotatably connect with side walls of the mounting groove.

7. The clamping mechanism of claim 6, wherein the clamping block comprises a clamping portion facing the mounting portion, a connecting portion and a rotating portion, the connecting portion perpendicularly extends from one end of the clamping portion, the rotating portion is formed by bending an end of the connecting portion away from the clamping portion, the rotating portion and the clamping portion are positioned at a same side of the connecting portion, the rotating portion extends into the mounting groove.

8. The clamping mechanism of claim 6, wherein the rotating portion comprises a first connecting end and a second connecting end opposite to the first connecting end, the first connecting end is rotatably connected with the base away from the connecting portion, the guiding member passes through the second connecting end and the first sliding segment.

9. The clamping mechanism of claim 8, wherein the clamping block further comprises a inserting groove, the inserting groove extends from the first connecting end to a middle of the clamping portion, the eccentric handler passes through the inserting groove.

10. The clamping mechanism of claim 1, wherein the clamping mechanism further comprises a shaft, the shaft passes through the hinged hole to connect with the base.

11. A clamping mechanism, comprising:
a base;
a clamping block comprising a clamping portion, a connecting portion perpendicularly extending from one end of the clamping portion, and a rotating portion formed by bending an end of the connecting portion away from the clamping portion, the rotating portion being rotatably connected with the base;
an eccentric handler defining a hinged hole and a sliding slot, a part of the sliding slot being eccentrically positioned relatively to the hinged hole, the eccentric handler hinged with the base via the hinged hole; and
a guiding member passing through the sliding slot and movably connected with the rotating portion away from the base,
wherein the eccentric handler is driven to enable and to force the guiding member to move along the sliding slot for clamping and releasing a workpiece on the base.

12. The clamping mechanism of claim 11, wherein the sliding slot comprises a first sliding segment and a second sliding segment extending from an end of the first sliding segment and is communicated with the first sliding segment, the first sliding segment is arc-shaped and is eccentrically positioned relatively to the hinged hole.

13. The clamping mechanism of claim 12, wherein the eccentric handler comprises a base body, a holding portion and a hinged portion, wherein the eccentric handler comprises a base body, a holding portion and a hinged portion, the holding portion is formed by bending one end of the base body, and the hinged portion 66 is formed by bending another end of the base body, the holding portion and the hinged portion are positioned at opposite ends of the base body, the hinged hole is positioned on the hinged portion, the first sliding segment and the second sliding segment are positioned on the base body, the second sliding segment is positioned adjacent to the hold portion.

14. The clamping mechanism of claim 13, wherein the base body comprise a position groove positioned on an edge of the base body adjacent to the hinged portion, the clamping mechanism further comprises a pivot, the clamping block is hinged with the base via the pivot, the pivot resists against a sidewall of the position groove when the guiding member reaches an end of the first sliding segment away from the second sliding slot.

15. The clamping mechanism of claim 11, wherein the clamping mechanism further comprises two pivots, each of the two pivot passes through the base and the rotating portion to rotatably connect to the base and the clamping block.

16. The clamping mechanism of claim 11, wherein the base comprises a bottom portion, a mounting portion opposite to the bottom portion, and a side portion connecting with the bottom portion and the mounting portion, the clamping portion is positioned towards the mounting portion, a mounting groove is defined on the side portion, the rotating portion extends into the mounting groove to rotatably connect with side walls of the mounting groove.

17. The clamping mechanism of claim 16, wherein the rotating portion comprises a first connecting end and a second connecting end opposite to the first connecting end, the first connecting end is rotatably connected with the base away from the connecting portion, the guiding member passes through the second connecting end and the first sliding segment.

18. The clamping mechanism of claim 17, wherein the clamping block further comprises an inserting groove, the inserting groove extends from the first connecting end to a middle of the clamping portion, the eccentric handler passes through the inserting groove.

19. The clamping mechanism of claim 11, wherein the clamping mechanism further comprises a shaft, the shaft passes through the hinged hole to connect with the base.
